(19) United States
(12) Patent Application Publication
(10) Pub. No.: US 2024/0013776 A1
(43) Pub. Date: Jan. 11, 2024

(54) SYSTEM AND METHOD FOR SCENARIO CONTEXT-AWARE VOICE ASSISTANT AUTO-ACTIVATION

(71) Applicant: GM GLOBAL TECHNOLOGY OPERATIONS LLC, Detroit, MI (US)

(72) Inventors: Xu Fang Zhao, LaSalle (CA); Alaa M. Khamis, Courtice (CA); Gaurav Talwar, Novi, MI (US); Kenneth R. Booker, Grosse Pointe Woods, MI (US)

(73) Assignee: GM GLOBAL TECHNOLOGY OPERATIONS LLC, Detroit, MI (US)

(21) Appl. No.: 17/861,756

(22) Filed: Jul. 11, 2022

(51) Int. Cl. G10L 15/08; G10L 15/22

(52) U.S. Cl. CPC G10L 15/08; G10L 15/22; G10L 2015/088; G10L 2015/225

(57) ABSTRACT

A system for scenario context-aware voice assistant auto-activation is provided. The system includes a microphone configured for providing data related to a word or a phrase spoken by a user, an operational device, and a computerized scenario context-aware voice assistant controller. The controller includes programming to recognize the word or the phrase within the data and identify a scenario context of the word or the phrase. The controller further includes programming to utilize the scenario context to associate the word or the phrase with a scenario context feature trigger configured for indicating a desired command of the user and command the operational device based upon the scenario context feature trigger associated with the word or the phrase.

### INTRODUCTION

The disclosure generally relates to a system and method for scenario context-aware voice assistant auto-activation.

Speech or voice recognition refers to a computerized method for translating audible speech into discernable inputs to computerized programming. Computerized programming may transform discernable inputs into commands that execute portions of the programming to achieve tangible results.

### SUMMARY

A system for scenario context-aware voice assistant auto-activation is provided. The system includes a microphone configured for providing data related to a word or a phrase spoken by a user, an operational device, and a computerized scenario context-aware voice assistant controller. The controller includes programming to recognize the word or the phrase within the data and identify a scenario context of the word or the phrase. The controller further includes programming to utilize the scenario context to associate the word or the phrase with a scenario context feature trigger configured for indicating a desired command of the user and command the operational device based upon the scenario context feature trigger associated with the word or the phrase.

In some embodiments, the programming to utilize the scenario context to associate the word or the phrase with the scenario context feature trigger is configured for enabling the computerized scenario context-aware voice assistant controller to proactively command the operational device based upon the scenario context.

In some embodiments, the computerized scenario context-aware voice assistant controller further includes programming to generate a candidate command based upon the scenario context feature trigger associated with the word or the phrase, generate an audio prompt to the user to confirm the candidate command, monitor feedback from the user to the audio prompt, and selectively command the operational device based upon the feedback.

In some embodiments, the programming to utilize the scenario context includes a machine learning algorithm configured for associating the word or the phrase with the scenario context feature trigger.

In some embodiments, the machine learning algorithm is configured for utilizing the feedback from the user to improve further associations.

In some embodiments, the operational device includes a cellular device, and the programming to command the operational device includes programming to execute a phone call.

In some embodiments, the operational device includes a navigational system, and the programming to command the operational device includes programming to create a navigational route.

In some embodiments, the operational device includes an entertainment system, and the programming to command the operational device includes programming to select one of a frequency modulation (FM) radio station, a satellite radio station, or a streaming audio software application.

In some embodiments, the operational device includes a web search device, and the programming to command the operational device includes programming to execute a web search and report upon the web search to the user.

In some embodiments, the operational device includes a climate control system, and the programming to command the operational device includes programming to change a set temperature of the climate control system.

According to one alternative embodiment, a system for scenario context-aware voice assistant auto-activation in a vehicle is provided. The system includes a microphone configured for providing data related to a word or a phrase spoken by a user, a vehicle operational device, and a computerized scenario context-aware voice assistant controller. The controller includes programming to recognize the word or the phrase within the data and identify a scenario context of the word or the phrase. The controller further includes programming to utilize the scenario context to associate the word or the phrase with a scenario context feature trigger configured for indicating a desired command of the user and command the vehicle operational device based upon the scenario context feature trigger associated with the word or the phrase.

In some embodiments, the microphone is further configured for providing the data related to a discernable sound made by the user. The computerized scenario context-aware voice assistant controller further includes programming to recognize a scenario context of the discernable sound to indicate that the user is drowsy or irritated and command the vehicle operational device based upon the scenario of the discernable sound.

In some embodiments, the computerized scenario context-aware voice assistant controller further includes programming to generate a candidate command based upon the scenario context feature trigger associated with the word or the phrase, generate an audio prompt to the user to confirm the candidate command, monitor feedback from the user to the audio prompt, and selectively command the operational device based upon the feedback.

In some embodiments, the programming to utilize the scenario context includes a machine learning algorithm configured for associating the word or the phrase with the scenario context feature trigger, and the machine learning algorithm is configured for utilizing the feedback from the user to improve further associations.

In some embodiments, the vehicle operational device includes one of a cellular device, a navigational system, an entertainment system, a web search device, or a climate control system.

According to one alternative embodiment, a method for scenario context-aware voice assistant auto-activation in a vehicle is provided. The method includes monitoring a microphone configured for providing data related to word or phrase spoken by a user. The method further includes, within a computerized processor, recognizing the word or the phrase within the data and identifying a scenario context of the word or the phrase. The method further includes, within the computerized processor, utilizing the scenario context to associate the word or the phrase with one of a plurality of scenario context feature triggers configured for indicating a desired command of the user and commanding an operational device within the vehicle based upon the scenario context feature trigger associated with the word or the phrase.

In some embodiments, utilizing the scenario context to associate the word or the phrase with the scenario context feature trigger includes enabling proactively commanding the operational device based upon the scenario context.

In some embodiments, the method further includes, within the computerized processor, generating a candidate command based upon the scenario context feature trigger associated with the word or the phrase and generating an audio prompt to the user to confirm the candidate command. The method further includes, within the computerized processor, monitoring feedback from the user to the audio prompt and selectively commanding the operational device based upon the feedback.

In some embodiments, utilizing the scenario context includes utilizing a machine learning algorithm configured for associating the word or the phrase with the scenario context feature trigger, and the machine learning algorithm is configured for utilizing the feedback from the user to improve further associations.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 schematically illustrates an exemplary system for scenario context-aware voice assistant auto-activation, in accordance with the present disclosure;

FIG. 2 schematically illustrates the context-aware trigger module of FIG. 1, in accordance with the present disclosure;

FIG. 3 schematically illustrates an exemplary method for scenario context-aware voice assistant auto-activation, in accordance with the present disclosure;

FIG. 4 schematically illustrates operation of the phone dialogue scenario model of FIG. 3, in accordance with the present disclosure;

FIG. 5 schematically illustrates the navigation dialogue scenario model of FIG. 3, in accordance with the present disclosure;

FIG. 6 schematically illustrates the media dialogue scenario model of FIG. 3, in accordance with the present disclosure;

FIG. 7 schematically illustrates an exemplary computerized scenario context-aware voice assistant controller configured for operating the disclosed method, in accordance with the present disclosure; and

FIG. 8 schematically illustrates an exemplary device embodied as a vehicle including the computerized scenario context-aware voice assistant controller of FIG. 7, in accordance with the present disclosure.

### DETAILED DESCRIPTION

Speech recognition or voice recognition may be utilized to provide control over a computer-controlled system. One may command through speech that a computer play a certain song, provide a current time of day, or initiate a particular phone call to a named person or business.

Speech may be used to command actions or command programming to execute, but some speech may not be intended to command a computer. One may say “It's hot outside” and intend the computer to change a temperature, or that person may be carrying on a conversation with another person and not intend the computer to take an action. A computerized system may include particular phrases that are required to translate speech into a command, for example, requiring every word in a phrase for the command to be recognized. Such a system may be difficult to use, as the user is tasked to remember command phrases verbatim, and accents or less than perfect elocution may prevent the computer from recognizing every word in a phrase consistently. In another system, a wake-up word or an action word to indicate that the user is talking to the computer is used to initiate voice recognition. For example, a computerized system may be programmed to be addressed as “Computer” before the system recognizes that the next phrase is intended as a command. In such a system, the phrase “lock the car” would not initiate a response from the system, while the phrase “Computer, lock the car” would be taken as command. While such a keyword or requirement to address the computer may avoid accidental activation of the system, such speech patterns are inconvenient and awkward for many users. Such a system requires that the user treat the computer as an entity, which many users do not want to do. Another system may require that a button be pressed to signal to the computerized system that the next audible words are to be taken a voice command. Such systems are inconvenient and rapidly fall out of use by users.

A computerized system and method are provided for scenario context-aware voice assistant auto-activation. Context is important to understanding speech. The disclosed system and method may utilize the context of a user's speech to increase or decrease confidence that a phrase is intended as a command to the system. By utilizing a scenario context, the use of a trigger word or an activation button may be eliminated, and casual speech patterns of the user may be used to provide or interpret control activation commands. By utilizing a scenario context, the system may operate a priori, acting based upon inferences or evidence of a user's intent, rather than waiting for the user to fully form an intention and make the decision to command action from the system. The system may be proactive rather than reactive. In one embodiment, a learning algorithm may additionally be utilized to reinforce particular patterns of control.

Context or scenario context may be described as evidence of proof that something is either more likely to be true or less likely to be true based upon available information in the environment. For example, if a user is presently in a telephone call with another person, it is less likely that the user is talking to the computer than if the user is not presently talking to another person. In another example, if a user says that it is cold, and an ambient temperature sensor may provide information that it is currently 90° F. at the current location of the user, the computer may determine that it is unlikely that the user wants the heater activated. However, if it is 20° F. at the current location of the user, the computer may determine that it is likely that the user wants the heater activated and utilize the statement by the user as a command to turn on the heater. In another example, if the user has a pattern of traveling home after work 98% of days, when the user states that she wants to go to a beach, the computer may determine that it is unlikely that the user wants a navigational route set for a beach. However, if the vehicle doors are opened and closed frequently and the vehicle suspension indicates that the vehicle is heavily laden with luggage and if the word beach is detected several times, the user stating that she wants to go to the beach may be used to indicate a likely command to set a navigational route for the beach. In this way, scenario context may be utilized to trigger or enable voice recognition commands.

Machine learning algorithms enable methods where responses in a computer may be made more likely or less likely based upon patterns of inputs to the computer. For example, if phone dialing commands are frequently overridden by the user, a machine learning algorithm may be utilized to learn that a perceived input command to dial the phone may be being misinterpreted and may be subsequently disabled or require additional confirmation to activate. In another example, if perceived commands to change volume on an audio system are repeatedly confirmed or allowed to stand by the user, the machine learning algorithm may reinforce or be more likely to enable volume controls based upon speech recognition due to the perceived positive feedback from the user. The machine learning algorithm may employ user specific weights or reinforcements. For example, by speech patterns, by measured weight upon a car seat, by key fob serial number, or by other similar methods, a computerized system may establish or estimate an identify of the present user. User A may prefer higher volume settings on the radio and may prefer voice activation of temperature controls, whereas user B may prefer quieter operation of the radio and may prefer manual control of temperature controls. Machine learning algorithms may be employed to improve selective activation of the system and method and improve user satisfaction with the selective activation.

The system and method may utilize a voice assistant, for example, requesting confirmation of the user. In one example, where a user states, “It is cold in here,” the voice assistant may provide an audible message “Would you like to turn on the heater?” In another example, where the user states “I need to talk to my spouse,” the voice assistance may provide an audible message “Would you like me to dial the phone to call your spouse?” The voice assistant may provide a user-friendly way to confirm or override commands that are received through speech recognition.

The disclosed system and method may be utilized within a device embodied as a vehicle upon a roadway, a boat, or other similar device. The disclosed system and method may similarly be utilized within a structure to provide control over systems and devices within the structure.

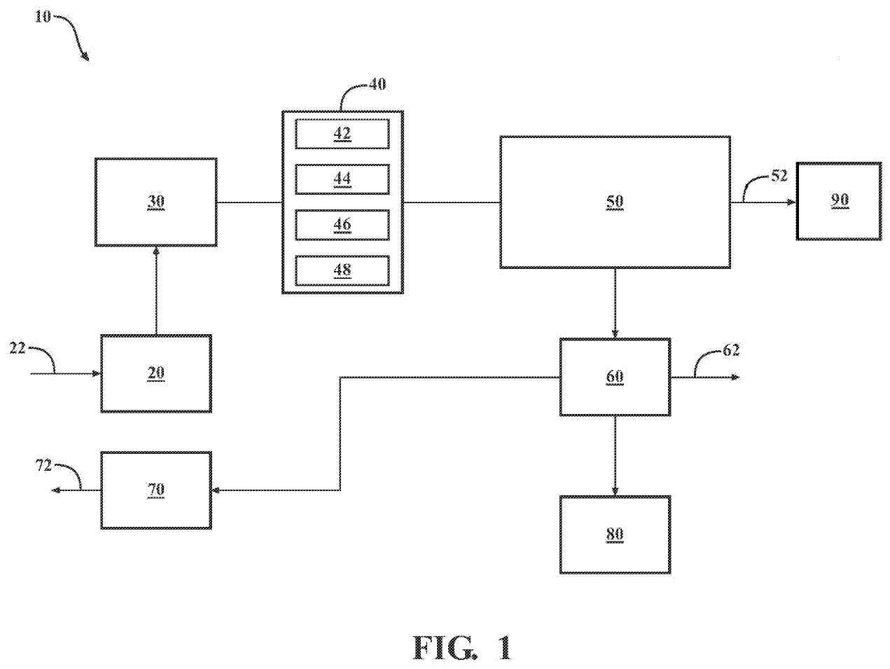

Referring now to the drawings, wherein like reference numbers refer to like features throughout the several views, FIG. 1 schematically illustrates an exemplary system 10 for scenario context-aware voice assistant auto-activation. The system 10 is illustrated including a microphone 20, an auto-extracted contextual information module 30, a context derivation module 40, a context-aware trigger module 50, a user confirmation module 60, an audio speaker 70, and a dialogue generation and management module 80. The microphone 20 is configured for monitoring sounds 22 which may include speech by a user of the system. The sounds 22 may further include noises that may be useful to providing context to the speech of the user. The auto-extracted contextual information module 30 is a computerized module configured for analyzing data provided by the microphone 20 and generating detected words, phrases, and discernable sounds from the data. The context derivation module 40 inputs the detected words, phrases, and discernable sounds from the auto-extracted contextual information module 30 and categorizes the detected words, phrases, and discernable sounds to identify a scenario context of the detected words, phrases, and discernable sounds. The context derivation module 40 may attempt to match words and/or phrases with programmed values or characteristics. For example, detected words, phrases, and discernable sounds may be categorized to indicate an identity or object (who?), a situational context (what?), a temporal context (when?), or a spatial context (where?). The context derivation module 40 is illustrated including four exemplary context models: an identity context model 42, a situational context model 44, a temporal context model 46, and a spatial context model 48. The context derivation module 40 may be programmed to recognize and categorize generic terms, such as home, father, tomorrow, and cold. The context derivation module 40 may further be programmed to recognize and categorize terms specific to a user, for example, learning the names of friends and family of a user through a contact list on the user's cellular device, recognizing a place of work for a user based upon travel patterns, and identifying patterns in the user's speech to indicate a desired command. The context derivation module 40 utilizes the detected words, phrases, and discernable sounds to determine categorized words and phrases for the purpose of determining, within the context-aware trigger module 50, presence of a scenario context feature trigger or an indication that the user intends or wished for a command to be given to the system.

The context-aware trigger module 50 receives the categorized words and phrases from the context derivation module 40. The context-aware trigger module 50 includes programming to compare the categorized words and phrases to a plurality of scenario context feature triggers or potential indications that the user intends or wishes for a command to be given to the system.

Based upon the determined context of the words and phrases, the system 10 may determine desired commands of the user a priori or predictively. For example, the user may ask another vehicle occupant, “Are you hungry?” The system 10 may utilize the words, associating the words with a command to display nearby restaurants upon a display screen in the vehicle for navigational route selection and generation. In another example, the user may utter, “I'm tired of listening to the news,” and the system 10 may change a current radio station to a favorited music station of the user. By determining a context of words and phrases spoken by the user, the system may act proactively rather than reactively.

In one embodiment, the context-aware trigger module 50 includes a machine learning algorithm useful to compare the categorized words and phrases to the plurality of scenario context feature triggers. In this embodiment, as the context-aware trigger module 50 compares and matches the categorized words and phrases to a plurality of scenario context feature triggers, feedback to these matches may be used to reinforce or discourage similar matches in the future, thereby improving performance of the context-aware trigger module 50 through the included machine learning algorithm. As the context-aware trigger module 50 compares and matches the categorized words and phrases to the plurality of scenario context feature triggers, the context-aware trigger module 50 may generate commands 52 to vehicle operational device 90 being controlled and/or may generate prompts to confirm candidate commands. Operational devices may include temperature controls, audio system controls, telephone unit controls, or other similar devices or systems that may be controlled for the user.

Detected words, phrases, and discernable sounds may be determined to include commands for the system to generate certain outcomes. The system 10 may act with high confidence, requiring no confirmation and simply generating electronic commands based upon the detected words, phrases, and discernable sounds from the user. In another embodiment, the system 10 may act with low confidence, announcing a candidate command determined by context-aware trigger module 50 to the user and requesting the user to confirm the command. In another embodiment, the system 10 may evaluate a confidence level and selectively prompt the user to confirm a candidate command based upon the confidence level. Prompts to confirm candidate commands determined from detected words, phrases, and discernable sounds may be provided to user confirmation module 60, which may utilize the audio speaker 70 to prompt the user for feedback. If the user provides positive feedback, a command 62 to vehicle operational device 90 may be generated by the user confirmation module 60. If the user provides negative feedback, the process may be canceled, and the system 10 may await new inputs to start over. Positive and negative feedback may be provided to the dialogue generation and management module 80 to utilize computer processing to improve future communications with the user.

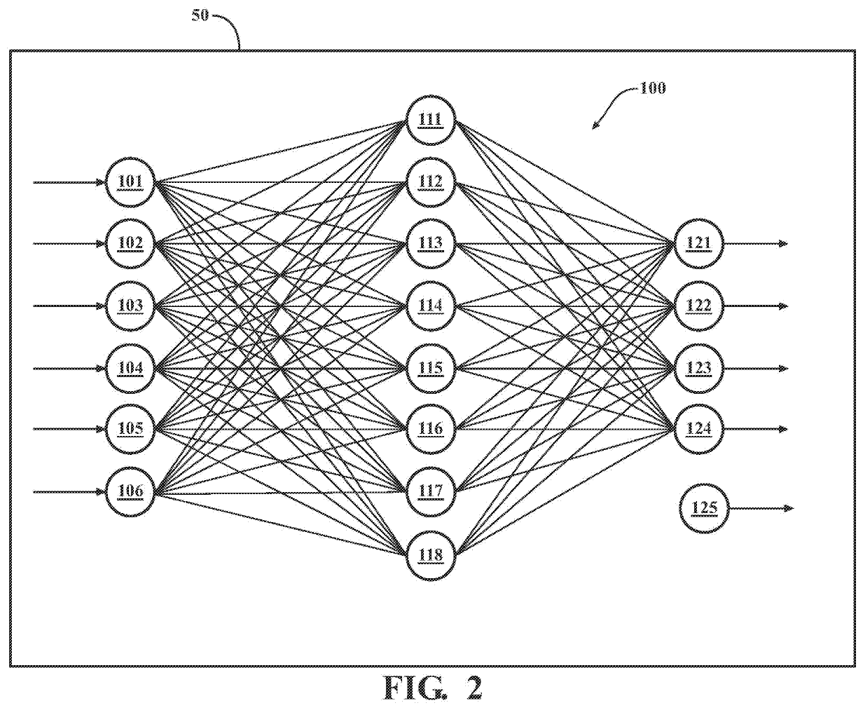

FIG. 2 schematically illustrates the context-aware trigger module 50 of FIG. 1. The context-aware trigger module 50 is illustrated including a machine learning algorithm 100. The context-aware trigger module 50 receives the categorized words and phrases 101, 102, 103, 104, 105, and 106 from the context derivation module 40 of FIG. 1. The context-aware trigger module 50 includes programming to compare the categorized words and phrases 101, 102, 103, 104, 105, and 106 to a plurality of scenario context feature triggers 111, 112, 113, 114, 115, 116, 117, and 118 or potential indications that the user intends or wished for a command to be given to the system. As the context-aware trigger module 50 compares and matches the categorized words and phrases to the plurality of scenario context feature triggers 111, 112, 113, 114, 115, 116, 117, and 118, feedback to these matches may be used to reinforce or discourage similar matches in the future, thereby improving performance of the context-aware trigger module 50 through the included machine learning algorithm 100. As the context-aware trigger module 50 compares and matches the categorized words and phrases to the plurality of scenario context feature triggers, commands 121, 122, 123, and 124 to specific systems may be generated by the context-aware trigger module 50. Out of domain commands 125 may further be generated. The commands 121, 122, 123, and 124 may collectively be described as commands 52 of FIG. 1.

The context-aware trigger module 50 may utilize a tiered approach to generating commands based upon the machine learning algorithm 100. For example, the context-aware trigger module 50 may initially request confirmation from a user when a new command is indicated or new words are interpreted to indicate a desire for a command. As positive confirmations are entered, the system may progressively act with higher confidence, eventually enacting the command without requested confirmation. As negative reactions from the user are entered, the system may eventually disassociate particular words with a particular candidate command.

The context-aware trigger module 50 may utilize detected words and phrases to determine commands that the user intends to provide to the system 10. The context-aware trigger module 50 may further analyze discernable sounds collected through the microphone 20 to modify vehicle operation based upon a determined condition of the user. For example, if the user is showing signs of drowsiness through repeated yawning, the system 10 may provide audio recommending that the user pull over or engage an autonomous driving system, or the system 10 may increase distance or time factors, for example, in driving aids, providing graphics to the user recommending a longer distance be maintained with a vehicle in front of the user's vehicle. In another example, if the user is determined to be agitated and yelling, the system 10 may determine the user to be distracted and activate enhanced lane keeping programming, such as utilizing haptic or vibrational outputs to the user to get the user's attention.

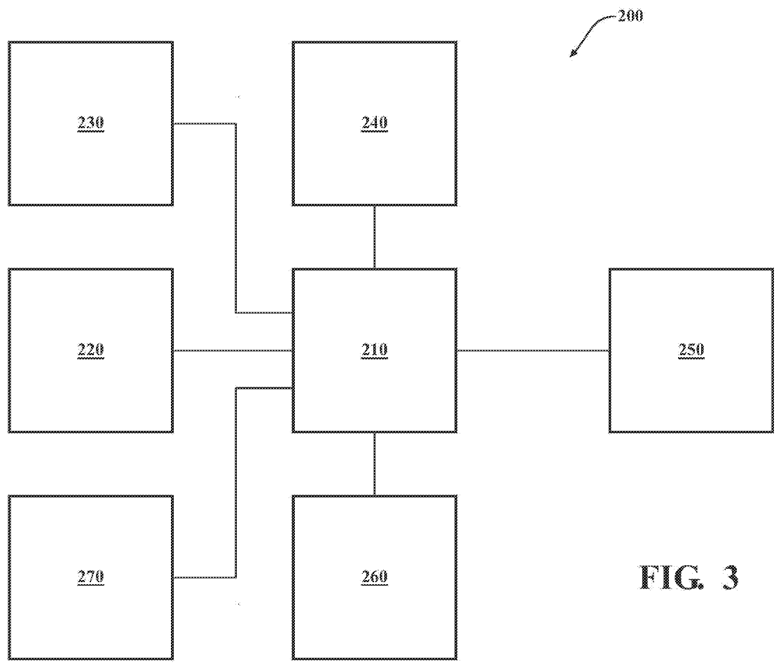

FIG. 3 schematically illustrates an exemplary method 200 for scenario context-aware voice assistant auto-activation. Method 200 may be operated through programming within the context-aware trigger module 50 of FIG. 1. Scenario dynamic dialogue model 210 is illustrated in communication with a plurality of scenario dialogue models, including an out of in-vehicle scenario model 220, a phone dialogue scenario model 230, a navigation dialogue scenario model 240, a media dialogue scenario model 250, a web search dialogue scenario model 260, and a vehicle domain dialogue scenario model 270. Each of the scenario dialogue models include programming to respond to a voice-activated trigger, such as one of the plurality of scenario context feature triggers 111, 112, 113, 114, 115, 116, 117, and 118 of FIG. 2. The out of in-vehicle scenario model 220 includes programming to operate scenarios outside of the vehicle, for example, managing reminders, shopping lists, and other information for the user.

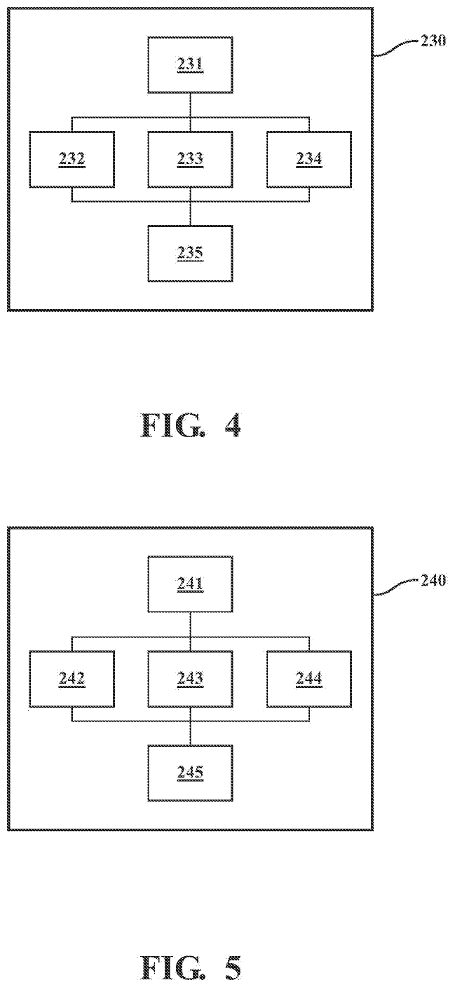

FIG. 4 schematically illustrates operation of the phone dialogue scenario model 230 of FIG. 3. The phone dialogue scenario model 230 receives a voice-activated trigger or wake-up word which is relayed to the phone dialogue scenario model 230 from the scenario dynamic dialogue model 210. The voice-activated trigger may be received in operation 231 and may include identified words and phrases that are determined to indicate an intended recipient of a telephone call. Three exemplary context operations are provided, including operation 232 which operates programming when a phone number is detected, operation 233 which operates programming when a pre-registered contact of the user is detected, and operation 234 which operates programming when a particular relation tag (e.g., my spouse, my mom, golf partner Mike, etc.) is detected. Operations 232, 233, and 234 are exemplary, and a number of additional or alternative context operations may be utilized. Each of the three exemplary context operations 232, 233, and 234 may be useful to transform the voice-activated trigger into a command to operate a cellular device, for example, including a smart-phone in the possession of the user and in wireless communication with the system. Based upon the voice-activated trigger and commands generated by the context operations 232, 233, and 234, operation 235 includes programming to relay commands and execute the desired phone call.

FIG. 5 schematically illustrates the navigation dialogue scenario model 240 of FIG. 3. The navigation dialogue scenario model 240 receives a voice-activated trigger or wake-up word which is relayed to the navigation dialogue scenario model 240 from the scenario dynamic dialogue model 210. The voice-activated trigger may be received in operation 241 and may include identified words and phrases that are determined to indicate commands related to creating or updating a navigational planned route. Three exemplary context operations are provided which may operate based upon a point of interest to be navigated to, including operation 242 which operates programming when a command to find a gas station is detected, operation 243 which operates programming when a command to find a restaurant is detected, and operation 244 which operates programming when a command to find a hotel is detected. Operations 242, 243, and 244 are exemplary, and a number of additional or alternative context operations may be utilized. Each of the three exemplary context operations 242, 243, and 244 may be useful to transform the voice-activated trigger into a command to create or update a route based upon an identified point of interest. Based upon the voice-activated trigger and commands generated by the context operations 242, 243, and 244, operation 245 includes programming to relay commands, for example, to a computerized vehicle navigational system and request a navigational route be determined.

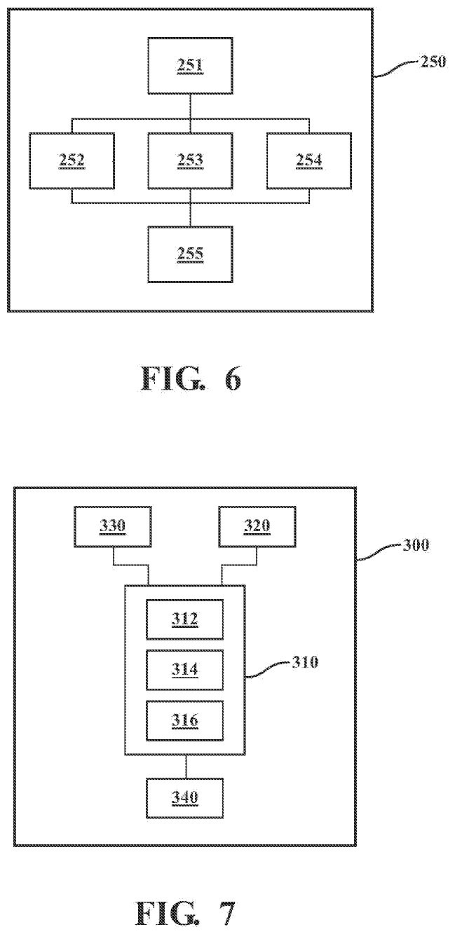

FIG. 6 schematically illustrates the media dialogue scenario model 250 of FIG. 3. The media dialogue scenario model 250 receives a voice-activated trigger or wake-up word which is relayed to the media dialogue scenario model 250 from the scenario dynamic dialogue model 210. The voice-activated trigger may be received in operation 251 and may include identified words and phrases that are determined to indicate commands related to controlling entertainment media such as satellite radio, frequency modulation (FM) radio, and music wireless streaming applications. Three exemplary context operations are provided which may operate based upon a user's request to access entertainment media, including operation 252 which operates programming when a command to access a satellite radio station is detected, operation 253 which operates programming when a command to access FM radio is detected, and operation 254 which operates programming when a command to activate a software application to access wireless streaming media is detected. Operations 252, 253, and 254 are exemplary, and a number of additional or alternative context operations may be utilized. Each of the three exemplary context operations 252, 253, and 254 may be useful to transform the voice-activated trigger into a command to access entertainment media. Based upon the voice-activated trigger and commands generated by the context operations 252, 253, and 254, operation 255 includes programming to relay commands, for example, to a computerized entertainment system controlling entertainment media.

Returning to FIG. 3, a web search dialogue scenario model 260 includes programming to receive a voice-activated trigger that may include identified words and phrases that are determined to indicate commands related to accessing information from the Internet. The web search dialogue scenario model 260 may further include programming to execute a web search, interpret information made available through the web search, and provide the information to the user. The information provided to the user may include speech, audio information, and/or information displayed upon a display screen such as a touch screen device. The vehicle domain dialogue scenario model 270 includes programming to receive a voice-activated trigger that may include identified words and phrases that are determined to indicated commands related to providing information about and control over vehicle systems. For example, the vehicle domain dialogue scenario model 270 may provide information regarding and control over vehicle systems. For example, information regarding a climate control system controlling a temperature within the vehicle and defogging/defrosting equipment to clear the windshield and control thereof may be provided. Similarly, control of headlight/fog light control systems, instrument panel control systems, seat positioning and heating systems, and other similar vehicle systems may be provided.

FIG. 7 schematically illustrates an exemplary computerized scenario context-aware voice assistant controller 300 configured for operating the disclosed method. Computerized scenario context-aware voice assistant controller 300 includes processing device 310, communications device 320, data input output device 330, and memory storage device 340. It is noted that computerized scenario context-aware voice assistant controller 300 may include other components and some of the components are not present in some embodiments.

The processing device 310 may include memory, e.g., read only memory (ROM) and random-access memory (RAM), storing processor-executable instructions and one or more processors that execute the processor-executable instructions. In embodiments where the processing device 310 includes two or more processors, the processors may operate in a parallel or distributed manner. Processing device 310 may execute the operating system of the computerized scenario context-aware voice assistant controller 300. Processing device 310 may include one or more modules executing programmed code or computerized processes or methods including executable steps. Illustrated modules may include a single physical device or functionality spanning multiple physical devices. In the illustrative embodiment, the processing device 310 also includes a speech identification and classification module 312, a context-aware trigger, confirmation, and feedback module 314, and a command execution module 316, which are described in greater detail below.

The data input output device 330 is a device that is operable to take data gathered from sensors and devices throughout the vehicle and process the data into formats readily usable by processing device 310. Data input output device 330 is further operable to process output from processing device 310 and enable use of that output by other devices or control modules throughout the vehicle.

The communications device 320 may include a communications/data connection with a bus device configured to transfer data to different components of the system and may include one or more wireless transceivers for performing wireless communication.

The memory storage device 340 is a device that stores data generated or received by the computerized scenario context-aware voice assistant controller 300. The memory storage device 340 may include, and is not limited to, a hard disc drive, an optical disc drive, and/or a flash memory drive.

The speech identification and classification module 312 monitors speech inputs and includes programming to operate the auto-extracted contextual information module 30 and the context derivation module 40 of FIG. 1.

The context-aware trigger, confirmation, and feedback module 314 includes programming to operate the context-aware trigger module 50 of FIG. 1. The context-aware trigger, confirmation, and feedback module 314 may further include programming to operate the user confirmation module 60 of FIG. 1, including programming to prompt the user to confirm commands and/or provide feedback regarding operation of the system, for example, for the purpose of fine-tuning operation of the machine learning algorithm 100 of FIG. 2.

The command execution module 316 may include programming to facilitate providing commands based upon voice-activated triggers identified by the system. For example, the command execution module 316 may store and provide information useful to interact with a cellular device of the user or multiple users of the vehicle. The command execution module 316 may include a history of voice-activated triggers provided by the user such that future commands may mimic or imitate previous successful commands. The command execution module 316 may include information such as favorite routes traveled by the user in previous travels or may include music genres favored by the user, such that similar satellite radio and FM radio stations may be suggested. The command execution module 316 may include programming to electronically change vehicle settings, such as a climate control set temperature or unlock a tailgate control.

Computerized scenario context-aware voice assistant controller 300 is provided as an exemplary computerized device capable of executing programmed code to accomplish the methods and processes described herein. A number of different embodiments of computerized scenario context-aware voice assistant controller 300, devices attached thereto, and modules operable therein are envisioned, and the disclosure is not intended to be limited to examples provided herein.

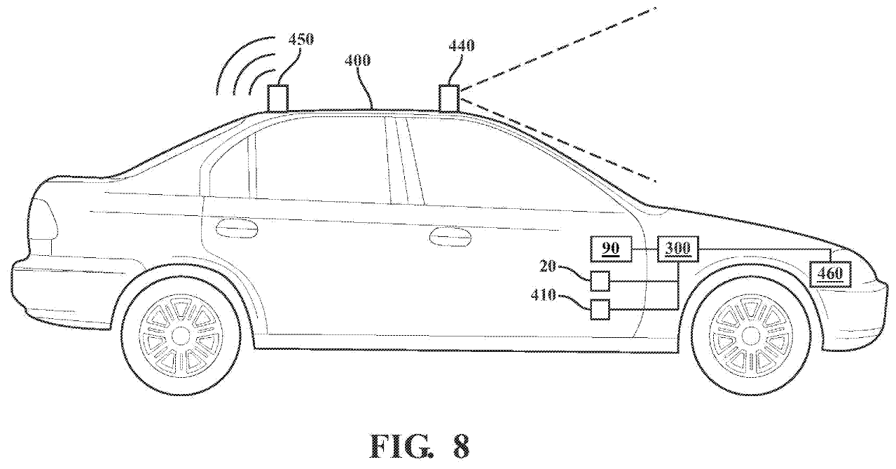

FIG. 8 schematically illustrates an exemplary device 400 embodied as a vehicle including the computerized scenario context-aware voice assistant controller 300 of FIG. 7. The device 400 further includes a vehicle propulsion system 460, a vehicle operational device 90, a microphone 20, and an audio system 410. The scenario context-aware voice assistant controller 300 may be in communication with the vehicle propulsion system 460, for example, to provide information and control over operation and movement of the vehicle. The scenario context-aware voice assistant controller 300 may be in communication with and provide control over the vehicle operational device 90, which may include a cellular device, a vehicle navigational system, an entertainment system, a web search device, and/or vehicle systems such as a climate control system. The microphone 20 may be operable to transform sounds including speech within the device 400 into data which may be analyzed and utilized by the disclosed system and method. The audio system 410 may include the audio speaker 70 and may provide audio feedback and confirmation inquiries to a user. The device 400 may further include vehicle sensors 440, such as a camera device or a light detection and ranging (LIDAR) device useful to provide information relative to an operating environment of the vehicle. The device 400 may further include a wireless communication device 450 useful to communicate internally within the device, for example, with a cellular device of the user, and externally, for example, with a remote server device operating a streaming audio service, an FM radio transmitter, and/or a satellite providing satellite radio signals.

While the best modes for carrying out the disclosure have been described in detail, those familiar with the art to which this disclosure relates will recognize various alternative designs and embodiments for practicing the disclosure within the scope of the appended claims.

What is claimed is:

1. A system for scenario context-aware voice assistant auto-activation, comprising:
a microphone configured for providing data related to a word or a phrase spoken by a user;
an operational device; and
a computerized scenario context-aware voice assistant controller, including programming to:
recognize the word or the phrase within the data;
identify a scenario context of the word or the phrase;
utilize the scenario context to associate the word or the phrase with a scenario context feature trigger configured for indicating a desired command of the user; and
command the operational device based upon the scenario context feature trigger associated with the word or the phrase.

2. The system of claim 1, wherein the programming to utilize the scenario context to associate the word or the phrase with the scenario context feature trigger is configured for enabling the computerized scenario context-aware voice assistant controller to proactively command the operational device based upon the scenario context.

3. The system of claim 1, wherein the computerized scenario context-aware voice assistant controller further includes programming to:
generate a candidate command based upon the scenario context feature trigger associated with the word or the phrase;
generate an audio prompt to the user to confirm the candidate command;
monitor feedback from the user to the audio prompt; and
selectively command the operational device based upon the feedback.

4. The system of claim 3, wherein the programming to utilize the scenario context includes a machine learning algorithm configured for associating the word or the phrase with the scenario context feature trigger.

5. The system of claim 4, wherein the machine learning algorithm is configured for utilizing the feedback from the user to improve further associations.

6. The system of claim 1, wherein the operational device includes a cellular device; and
wherein the programming to command the operational device includes programming to execute a phone call.

7. The system of claim 1, wherein the operational device includes a navigational system; and
wherein the programming to command the operational device includes programming to create a navigational route.

8. The system of claim 1, wherein the operational device includes an entertainment system; and
wherein the programming to command the operational device includes programming to select one of a frequency modulation (FM) radio station, a satellite radio station, or a streaming audio software application.

9. The system of claim 1, wherein the operational device includes a web search device; and
wherein the programming to command the operational device includes programming to execute a web search and report upon the web search to the user.

10. The system of claim 1, wherein the operational device includes a climate control system; and
wherein the programming to command the operational device includes programming to change a set temperature of the climate control system.

11. A system for scenario context-aware voice assistant auto-activation in a vehicle, comprising:
a microphone configured for providing data related to a word or a phrase spoken by a user;
a vehicle operational device; and
a computerized scenario context-aware voice assistant controller, including programming to:
recognize the word or the phrase within the data;
identify a scenario context of the word or the phrase;
utilize the scenario context to associate the word or the phrase with a scenario context feature trigger configured for indicating a desired command of the user; and
command the vehicle operational device based upon the scenario context feature trigger associated with the word or the phrase.

12. The system of claim 11, wherein the microphone is further configured for providing the data related to a discernable sound made by the user; and
wherein the computerized scenario context-aware voice assistant controller further includes programming to:
recognize a scenario context of the discernable sound to indicate that the user is drowsy or irritated; and
command the vehicle operational device based upon the scenario context of the discernable sound.

13. The system of claim 11, wherein the computerized scenario context-aware voice assistant controller further includes programming to:
generate a candidate command based upon the scenario context feature trigger associated with the word or the phrase;
generate an audio prompt to the user to confirm the candidate command;
monitor feedback from the user to the audio prompt; and
selectively command the operational device based upon the feedback.

14. The system of claim 13, wherein the programming to utilize the scenario context includes a machine learning algorithm configured for associating the word or the phrase with the scenario context feature trigger; and
wherein the machine learning algorithm is configured for utilizing the feedback from the user to improve further associations.

15. The system of claim 11, wherein the vehicle operational device includes one of a cellular device, a navigational system, an entertainment system, a web search device, or a climate control system.

16. A method for scenario context-aware voice assistant auto-activation in a vehicle, comprising:
monitoring a microphone configured for providing data related to a word or a phrase spoken by a user;
within a computerized processor,
recognizing the word or the phrase within the data;
identifying a scenario context of the word or the phrase;
utilizing the scenario context to associate the word or the phrase with a scenario context feature trigger configured for indicating a desired command of the user; and
commanding an operational device within the vehicle based upon the scenario context feature trigger associated with the word or the phrase.

17. The method of claim 16, utilizing the scenario context to associate the word or the phrase with the scenario context feature trigger includes enabling proactively commanding the operational device based upon the scenario context.

18. The method of claim 16, further comprising, within the computerized processor:
generating a candidate command based upon the scenario context feature trigger associated with the word or the phrase;
generating an audio prompt to the user to confirm the candidate command;
monitoring feedback from the user to the audio prompt; and
selectively commanding the operational device based upon the feedback.

19. The method of claim 18, wherein utilizing the scenario context includes utilizing a machine learning algorithm configured for associating the word or the phrase with the scenario context feature trigger; and
wherein the machine learning algorithm is configured for utilizing the feedback from the user to improve further associations.
